(19) United States
(12) Patent Application Publication
(10) Pub. No.: US 2004/0050659 A1
(43) Pub. Date: Mar. 18, 2004

(54) Conveyor

(76) Inventors: Aksel Molbaek Jensen, Viby J (DK); Karsten Nielsen, Silkeborg (DK)

Correspondence Address: BIRCH STEWART KOLASCH & BIRCH, PO BOX 747, FALLS CHURCH, VA, 22040-0747, US

(21) Appl. No.: 10/381,472

(22) PCT Filed: Sep. 26, 2001
(86) PCT No.: PCT/DK01/00614

(30) Foreign Application Priority Data
Sep. 26, 2000 (DK) PA 2000 01424

(51) Int. Cl. B65G 43/08

(52) U.S. Cl. 198/395

(57) ABSTRACT

A method ad an apparatus is disclosed for providing a correct orientation of articles prior to introduction on a main conveyor in order to provide articles from tipping over or even fall off the conveyor during conveyance. The dimensions of the articles in the cross-section perpendicular to the transport direction are measured and it is determined whether to tilt the article by means of a tilt device comprising two belt conveyors arranged perpendicularly and being tiltable about an axis parallel to the transport direction. Furthermore, a conveyor is disclosed, comprising a device, for discharging articles from trays conveyed on the conveyor in which a discharge conveyor unit holding the tray is shifted to the side and tilted while the trays is kept in place so as to discharge the article thereon, when simultaneously a second conveyor unit is shifted into the conveying path so that the path is unbroken and allows for passage of trays during the discharge operation.

The present invention relates according to a first aspect to a method and an apparatus for providing a correct orientation of articles prior to induction on a main conveyor in order to provide articles from tipping over or even fall off the conveyor during conveyance. The dimensions of the articles in the cross-section perpendicular to the transport direction are measured and it is determined whether to tilt the article by means of a tilt device comprising two belt conveyors arranged perpendicularly and being tiltable about an axis parallel to the transport direction.

The present invention relates according to a second aspect to a conveyor comprising a device for discharging articles from trays conveyed on the conveyor in which a discharge conveyor unit holding the tray is shifted to the side and tilted while the trays is kept in place so as to discharge the article thereon, when simultaneously a second conveyor unit is shifted into the conveying path so that the path is unbroken and allows for passage of trays during the discharge operation.

### BACKGROUND OF THE INVENTION

When luggage articles, primarily suitcases, are checked into a conveyor system in e.g. an airport, the articles are typically placed on a check-in conveyor so that the cross-section of the article as seen in the transport direction of the conveyor shows a small width as compared to the height, for which reason the article is less stable. It situated with that orientation on a conveyor, that be a tilt-tray or cross-belt sorter or a belt conveyor, the article is likely to tip over during conveyance and even fall off the conveyor, causing damage to the article itself or the sorter and possibly a halt of the operation of the sorter. The problems are particularly severe for conveyors in which the articles are situated on trays or totes having a concave shape or the article-supporting surface to facilitate the discharge of articles, such as shown in WO 99/30993, because the totes provide an even less stable support for the articles.

A common solution is to tilt the articles with a wedge placed on the check-in conveyor or to hav a stationary inclination of the check-in c nveyor ov r a distance that all articles pass and the less stable of the articles will turn over and change their orientation.

From U.S. Pat. No. 3,666,073 it is known to tilt luggage at a check-in desk by means of two, parallel belt units that for each piece of luggage tilt towards each other about a common horizontal axis. The belt units tilts back to horizontal and are both operated to discharge the piece of luggage to e.g. a receiving belt unit. The piece of luggage should now be situated with the centre of gravity closest to the surface on which itrests, whether or not it was tilted by the operation. The operation is performed for each piece of luggage which blocks the transport path way for other pieces of luggage and limits the capacity of the check-in desk.

The solution according to the first aspect of the present invention is advantageous because the tilting of the articles is performed only if required, thus raising the capacity as the article is just passing the device if there is no requirement for tilting, the operation is performed in a controlled manned with as little strain on the articles as possible and producing less noise and thus-being advantageous from a working environmental view point. Finally, the arrangement of two belts with a constant angle there between and tiling together is much simpler in construction and operation than two belt units tilting individually.

The discharge of articles which are situated on trays or totes and are transported on a conveyor, such as a belt conveyor, is today commonly performed by diverting the tray from the conveyor path, e.g. by the use of a “pusher”, tilting the tray so as to discharge the article by letting the tray slide down an inclined plane and collide with a protrusion so as to stop the tray and let the article pass over the protrusion. Such discharge operations are noise generating, puts a lot of strain on the trays and require either a return conveyor for returning the trays after discharge to the induction stations where articles are inducted onto the trays and the sorter or a special arrangement for feeding the emptied trays back on the conveyor path.

Another solution to the discharge is to include a discharge conveyor in the conveying path at which the tray can be secured and tilted so as to discharge the article from the tray where after the discharge conveyor and the tray are returned to normal position and the emptied tray can be conveyed along with other loaded or empty trays on the same conveyor path. The disadvantag is that the conv yor path is blocked during the discharge operation and that th discharge rate is limited by th minimum time for a discharge operation because the blocked conveyor path does not allow trays to be conveyed to a other discharge conveyors discharging to the same article receiver.

The conveyor according to the second aspect of the invention allows the passage of trays during most time of a discharge operation, is gentle in the handling of trays and does not require a separate return conveyor for the trays. The discharge rate may be increased by providing two or more discharge conveyors discharging to the same article receiver and/or by allowing discharge to both sides of the conveyor path.

### BRIEF DESCRIPTION OF THE INVENTION

Thus the present invention relates in a first aspect to a method for providing a correct orientation of articles prior to induction on a main conveyor, comprising the steps of

(a) conveying the article from a feeding conveyor means onto an article supporting plane of a first conveyor means in a receiving position thereof, on which plane a first face of the article is supported,

(b) determining from physical characteristics of the article whether or not the orientation of the article is to be changed,

(c) selectively turning the first conveyor means as well as a second conveyor means about an axis being substantially parallel to a transport direction of the first and the second conveyor means so that the article becomes solely supported by a second face on an articles supporting plane of the second conveyor, and continue said turning until the articles supporting plane of the second conveyor is oriented substantially parallel to the article-supporting plane of the first conveyor in its receiving position so as to change the orientation of the article, and

(d) conveying the article from the first conveyor means, respectively from the second conveyor means, in the transport direction thereof for induction onto a main conveyor.

The step (b) of determining whether the orientation is to be changed may in a preferred embodiment comprise the steps of

(b1) detecting a first measure of the width of the article in a direction transverse to the transport direction by means of width detection means and providing a first output to a control unit accordingly,

(b2) detecting a second measure of the height of the article in a-direction perpendicularly to the transport direction and to the width by means of height detection means and providing a second output to the control unit accordingly,

(b3) determining by means of the control unit whether or not the orientation of the article is to be changed from combining said first and second output with predetermined rules, and

(b4) selectively effectuating the turning by means of the control unit

In particular, the width detection means may comprise a plurality of photo cells arranged with a substantially uniform mutual spacing in a direction transverse to the transport direction with lines of detection extending parallel through the path of conveyed articles, and the height detection means may comprise a plurality of photo cells arranged with a substantially uniform mutual spacing in a direction perpendicularly to the transport direction and to the width with lines of detection extending parallel through the path of conveyed articles, so that the first output and the second output indicating the number of photo cells of which the detection line is blocked by an article of the width detection means and the height detection means, respectively.

The present invention relates according to the first aspect furthermore to an apparatus for providing a correct orientation of articles prior to induction on a main conveyor, the apparatus comprising

a feeding conveyor having conveyor means for conveying articles in a transport direction thereof,

a tilt device having first conveyor means and second conveyor means defining a first and a second article-supporting surface extending substantially perpendicularly and having a common transport direction, the tilt device being pivotally arranged about an axis being substantially parallel to the transport direction,

tilting means for tilting the tilt device between a receiving position in which the first article-supporting surface is arranged to receive articles from the feeding conveyor and a tilted position in which the second article-supporting surface is arranged parallel to the first article-supporting surface in the receiving position,

a receiving conveyor having conveyor means arranged to receive articles from the first conv yor means when the tilt device is in the receiving position as well as from th second conveyor means wh n the tilt device is in the tilted position, and

a control unit being adapted to operate the conveyor means of the apparatus, to receive physical characteristics of an article situated on the first conveyor means in the receiving position of the tilt device, from these characteristics determine whether or not the orientation of the article is to be changed, selectively operating the tilting means so that the article becomes solely supported by the second articles-supporting plane, and continue said turning until the tilt device is in the tilted position.

In particular may the receiving conveyor be arranged to receive articles in one horizontal plane from the first as well as the second conveyor means.

The apparatus may comprise width detection means for detecting a first measure of the width of the article in a direction transverse to the transport direction and providing a first output to a control unit accordingly, and height detection means for detecting a second measure of the height of the article in a direction perpendicularly to the transport direction as well as to the width and providing a second output to the control unit accordingly, the first output and the second output constituting physical characteristics of the article. These width detection means may preferably comprise a plurality of photo cells arranged with a substantially uniform mutual spacing in a direction transverse to the transport direction with lines of detection extending parallel through the path of conveyed articles, and the height detection means may similarly comprise a plurality of photo cells arranged with a substantially uniform mutual spacing in a direction perpendicularly to the transport direction and to the width with lines of detection extending parallel through the path of conveyed articles, the first output and the second output indicating the number of photo cells of which the detection line is blocked by an article of the width detection means and the height detection means, respectively.

The present invention relates according to a second aspect to a conveyor comprising

a plurality of conveyor sections each comprising conveyor means having a transport direction and being arranged to form a single conveying path, and

a plurality of trays for being conveyed along said conveying path by means of said conveyor means and each defining an article-supporting surface, wherein at least one of the conveyor sections is a discharge section for discharging articles from the trays, the discharge section comprising

a first unit having first conveyor means and securing m ans for prev nting a tray situated on the first unit from sliding off the first unit when situated in a position transversally inclined with respect to the transport direction thereof,

a second unit arranged parallel to the first unit and having second conveyor means, and

shifting means for shifting the first unit transversally with respect to the transport direction from a conveying position, in which the subsequent conveyor section and the preceding conveyor section are interconnected by means of the first unit forming part of the conveyor path, and to a discharge position in which a tray situated on the first unit is transversally inclined with respect to the transport direction so as to discharge an article supported on the tray, the shifting means simultaneously shifting the second unit into a conveying position thereof in which the subsequent conveyor section and the preceding conveyor section are interconnected by means of the second unit forming part of the conveying path.

The second unit of the discharge section may also comprise securing means for preventing a tray situated on the second unit from sliding off the second unit when situated in a position transversally inclined with respect to the transport direction thereof, the shifting means further being arranged for shifting the first unit from the discharge position and to the conveying position and simultaneously shifting the second unit transversally with respect to the transport direction to a discharge position in which a tray situated on the second unit is transversally inclined with respect to the transport direction so as to discharge an article supported on the tray. Thereby, the second unit may be used for discharge of articles to the opposite side of the conveyor path as the first unit, which either may be used for a separate discharge destination or for the same destination as the first unit, thereby increasing the discharge rate for a given destination.

Furthermore, the conveyor may comprise at least two immediately adjacent discharge stations arranged to discharge articles to the same article-receiving means whereby the discharge rate for the destination associated with the article-receiving means is increased.

In a preferred embodiment, the tray supporting plane of the first unit and a tray supporting plane of the second unit are arranged with a constant angle there between, preferably an angle in the range of 120-150 degrees, most preferred in the range of 130-140 degrees.

It is preferred that the trays are similar to those disclosed in th international application WO 99/30993 by the applicant, thus that said trays have an upper surface of a concave shape as viewed in a cross-section perpendicular to the transport direction of the conveyor. Furthermore, the upper surface of said trays may be coated with a friction increasing material.

It is also preferred that the trays when being in the discharge position are inclined in the range of 30-60 degrees, preferably in the range of 40-50 degrees, with respect to the position of the trays being in the article-supporting and conveying position.

### BRIEF DESCRIPTION OF THE DRAWINGS

Different embodiments of the present invention are, shown in the appended figures in order to illustrate some of the possibilities of the aspects of the present invention. All measures are given in millimetres. The figures show the following:

FIG. 1 shows a cross-section as seen in the transport direction of two tilt devices according to the first aspect of the invention,

FIG. 2 is a side view of the devices of FIG. 1 together with the receiving conveyor,

FIGS. 3-14 show steps of the operation of a first embodiment of a discharge device according to the second aspect of the present invention and having two, parallel discharge conveyor units for two-sided discharge, of which figures

FIG. 3 is a perspective view of said first embodiment in a first operational step,

FIG. 4 is a cross-section of the device of FIG. 3,

FIG. 5 is a perspective view of said first embodiment in a second operational step,

FIG. 6 is a cross-section of the device of FIG. 5,

FIG. 7 is a perspective view of said first embodiment in a third operational step,

FIG. 8 is a cross-section of the device of FIG. 7,

FIG. 9 is a perspective view of said first embodiment in a fourth operational step,

FIG. 10 is a cross-section of the device of FIG. 9,

FIG. 11 is a perspective view of said first embodiment in a fifth operational step,

FIG. 12 is a cross-section of the device of FIG. 11,

FIG. 13 is a perspective view of said first embodiment in a sixth operational step,

FIG. 14 is a cross-section of the device of FIG. 13,

FIGS. 15a and 15b is a principle sketch of an operation sequence of said first embodiment of the discharge device,

FIGS. 16-20 show steps of the operation of a second embodiment of a discharge device according to the second aspect of the present invention and having two consecutive sets of two, parallel discharge conveyor units for one-sided discharge, of which figures

FIG. 16 is a perspective view of said second embodiment in a first operational step,

FIG. 17 is a perspective view of said second embodiment in a second operational step,

FIG. 18 is a perspective view of said second embodiment in a third operational step,

FIG. 19 is a perspective view of said second embodiment in a fourth operational step,

FIG. 20 is a perspective view of said second embodiment in a fifth operational step,

FIGS. 21a and 21b is a principle sketch of an operation sequence of said second embodiment of the discharge device,

FIGS. 22-25 show steps of operation of a third mbodiment of a discharg device according to the second aspect of the present invention and having two consecutive sets of two, parallel discharge conveyor units for double-sided discharge, of which figures

FIG. 22 is a perspective view of said third embodiment in a first operational step,

FIG. 23 is a perspective view of said third embodiment in a second operational step,

FIG. 24 is a perspective view of said third embodiment in a third operational step,

FIG. 25 is a perspective view of said third embodiment in a fourth operational step,

FIGS. 26-37 show steps of the operation of a fourth embodiment of a discharge device according to the second aspect of the present invention and having two, parallel discharge conveyor units for two-sided discharge, of which figures

FIG. 26 is a perspective view of said fourth embodiment in a first operational step,

FIG. 27 is a cross-section of the device of FIG. 26,

FIG. 28 is a perspective view of said fourth embodiment in a second operational step,

FIG. 29 is a cross-section of the device of FIG. 28,

FIG. 30 is a perspective view of said fourth embodiment in a third operational step,

FIG. 31 is a cross-section of the device of FIG. 30,

FIG. 32 is a perspective view of said fourth embodiment in a fourth operational step,

FIG. 33 is a cross-section of the device of FIG. 32,

FIG. 34 is a perspective view of said fourth embodiment in a fifth operational step,

FIG. 35 is a cross-section of the device of FIG. 34,

FIG. 36 is a perspective view of said fourth embodiment in a sixth operational step,

FIG. 37 is a cross-section of the device of FIG. 36,

FIG. 38 shows one possible arrangement of two parallel and connected conveyor sections for two-sided discharge,

FIG. 39 shows a second possible arrangement of two parallel and connected conveyor sections for two-sided discharge, and

FIG. 40 shows a third possible arrangement of two parallel and connected conveyor sections for two-sided discharge.

### DESCRIPTION OF EMBODIMENTS OF THE INVENTION SHOWN IN THE FIGURES

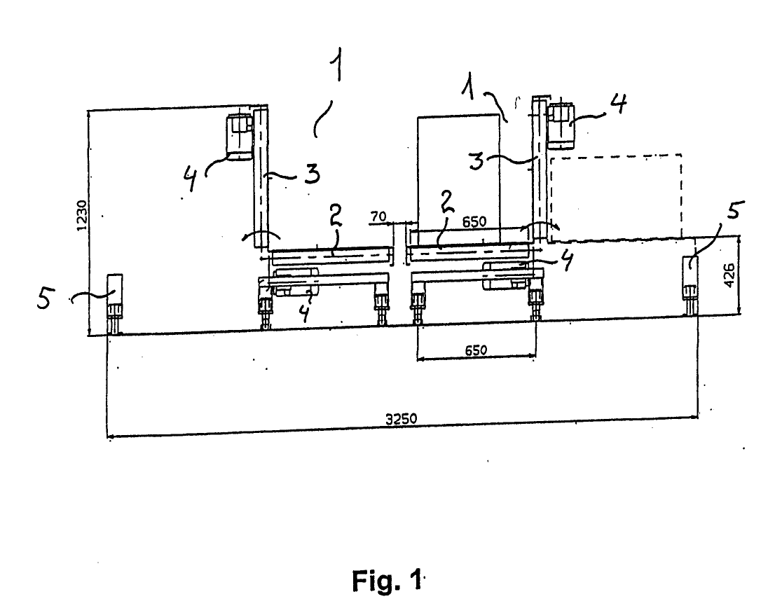

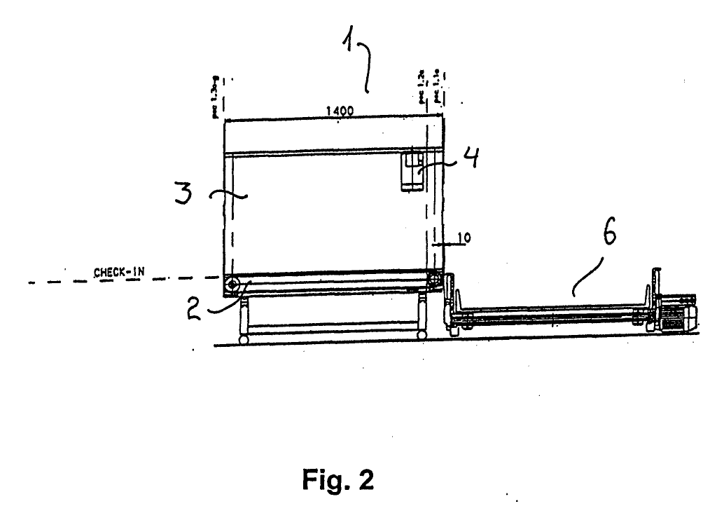

FIG. 1 shows a cross-section as seen in the transport direction of two tilt devices 1 according to the first aspect of the invention. Each device comprises a first conveyor means 2 and a second conveyor means 3 each having drive means 4 for driving the conveyor means 2, 3. The devices 1 are selectively tiltable about an axis normal to the cross-section so that an article that is conveyed onto the first conveyor means 2 and which has been decided to be tilted is transferred to the second conveyor means 3 by means of tilting the device 1 as indicated by the arrows. The outer ends of the second conveyor means 3 are in the tilted position of the device 1 supported by support means 5. The tilt device 1 is shown from the side in FIG. 2 together with the receiving conveyor 6 which is arranged for receiving articles from the fist conveyor means 2 in the untilted position of the device 1 as well as from the second conveyor means 3 in the tilted position of the device 1.

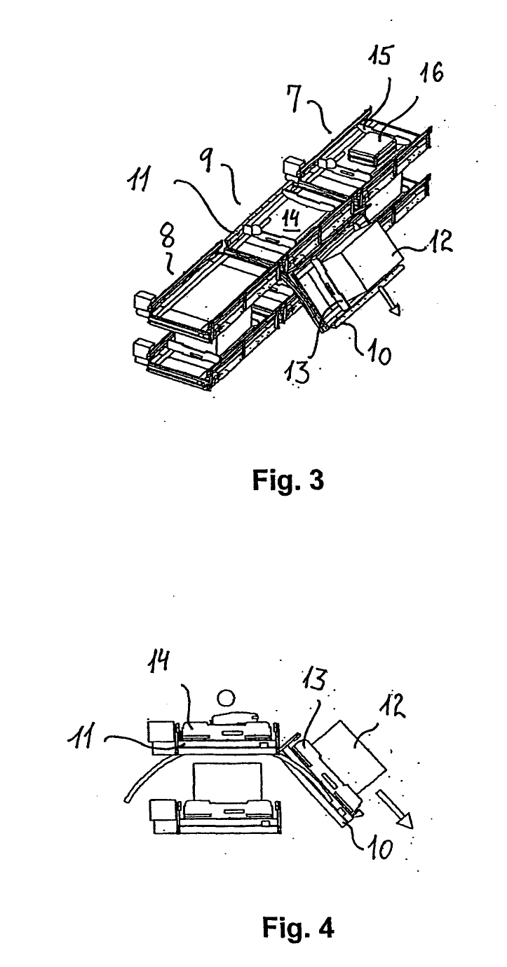

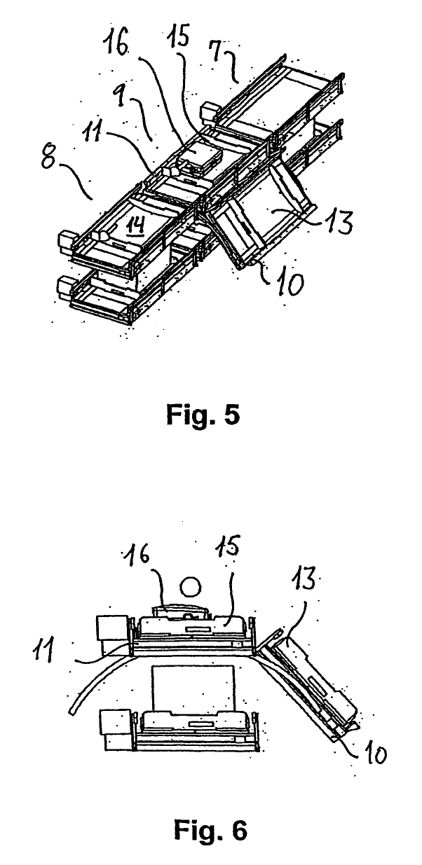

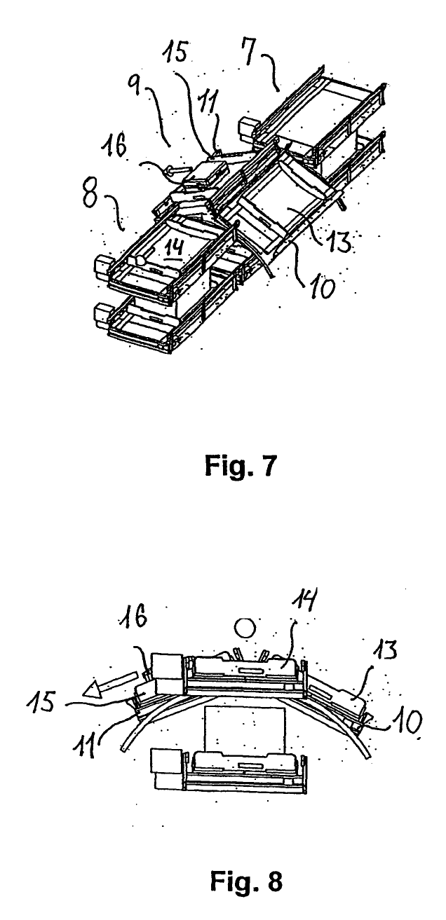

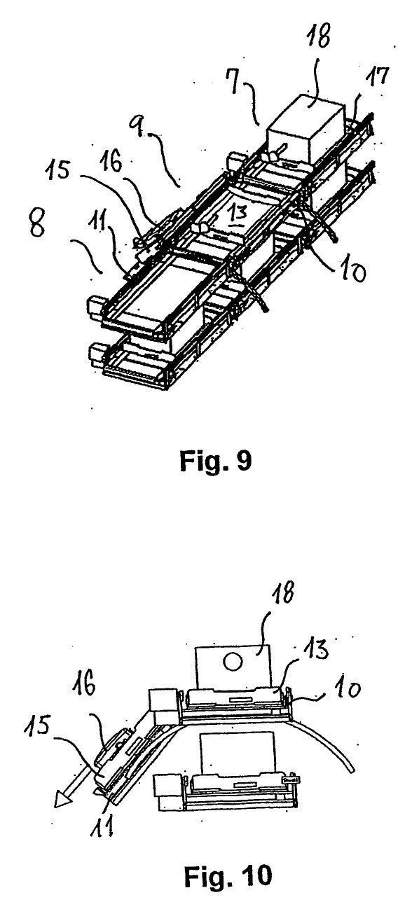

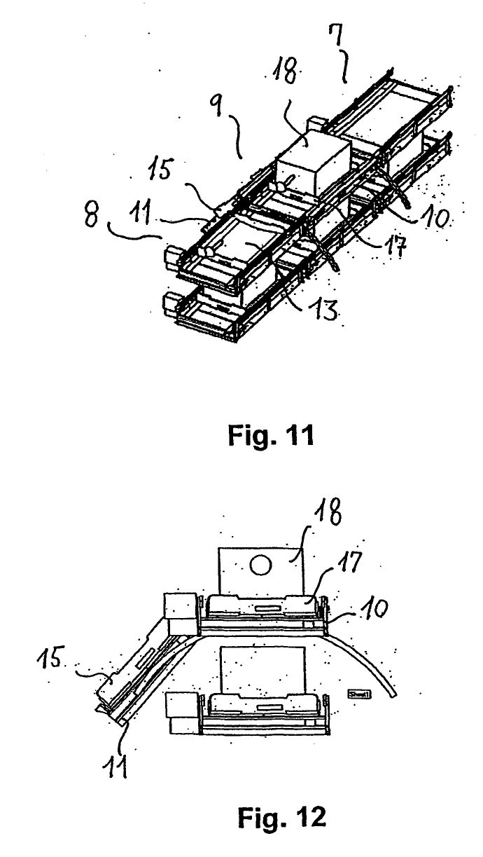

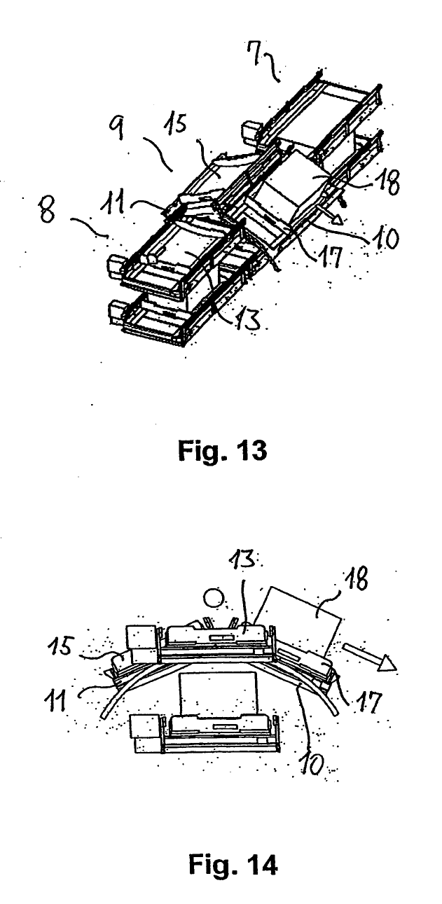

A first embodiment of the present invention according to the second aspect thereof is shown in FIGS. 3-14, in which the conveyor comprises a preceding conveyor section 7, a subsequent conveyor section 8 and a discharge conveyor section 9. For illustration, another conv yor is shown below the conveyor with the discharge cony yor section 9 whereby it is demonstrated that this type of discharge section 9 allows for close vertical proximity between conveyors. The discharge conveyor section 9 comprises two parallel conveyor units 10, 11 which may be shifted together in the direction transversal to the transport direction of the conveyors 7, 8, 9 between two positions. In FIGS. 3 and 4, one position is shown, in which an article 12 is discharged, as indicated by the arrow, from a tray 13 secured by securing means to the first conveyor unit 10 whereas an empty tray 14 is present on the second conveyor unit 11. In the next step shown in FIGS. 5 and 6, the empty tray 14 is conveyed from the second conveyor unit 11 onto the subsequent conveyor section 8 and the second conveyor unit 11, which in the present position closes the conveying path between the two adjacent conveyors 7, 8, has received another tray 15 from the preceding conveyor section 7. In the following step shown in FIGS. 7 and 8, the discharge conveyor section 9 is tilted so that the article 16 on the tray 14 will be discharged and the first conveyor unit 10 will close the conveying path between the two adjacent conveyors 7, 8. The resulting position is shown In FIGS. 9 and 10, and a new tray 17 with an article 18 thereon is approaching the discharge section 9 from the preceding conveyor 7. It is shown in FIGS. 11 and 12 that the tray 17 is conveyed onto the first conveyor section 10 while the emptied tray 13 is conveyed onto the subsequent conveyor section 8. The newly arrived tray 17 may be conveyed directly onto the subsequent conveyor section 8 for e.g. discharge or storage further downstream the conveyor line or may be emptied by the discharge conveyor section 9 as shown in FIGS. 13 and 14, in which the section 9 tilted back to the starting position of FIGS. 3 and 4.

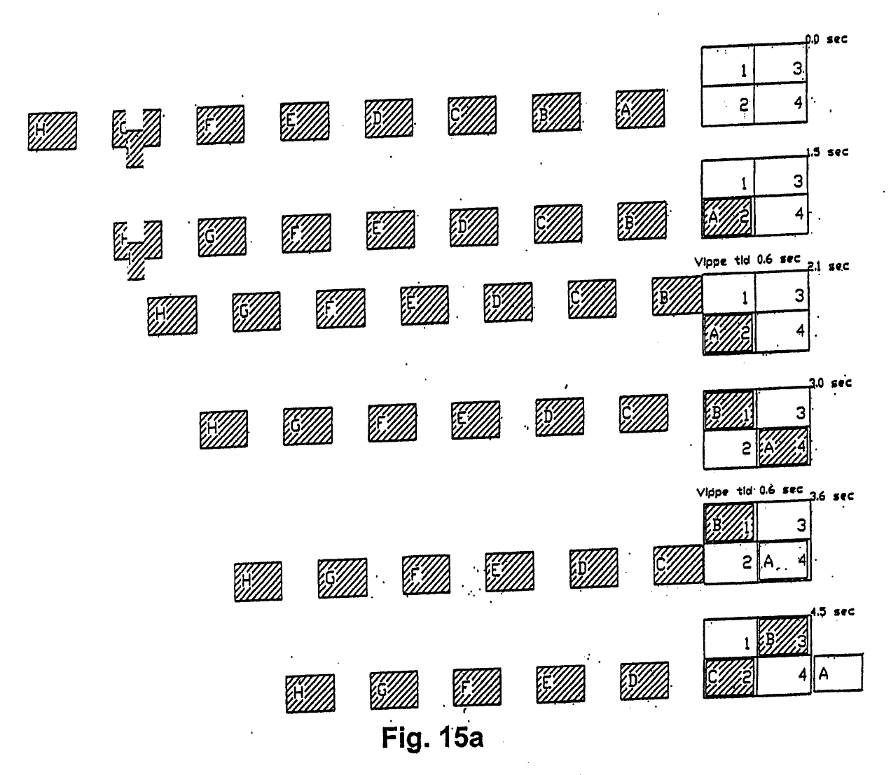

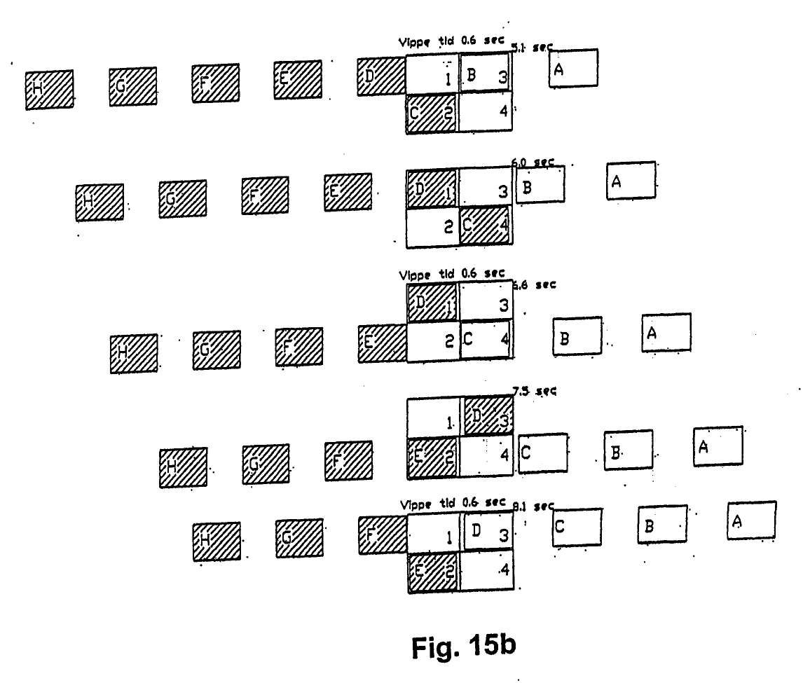

A discharge sequence of a device according to the first embodiment is illustrated in FIGS. 15a and 15b in which the positions 1 and 3 indicate the upstream position and the downstream position on the second conveyor unit 11 and the positions 2 and 4 indicate the upstream position and the downstream position on the first conveyor unit 10. The concept of upstream and downstream positions is not necessarily physical as a physical difference in the positions is not shown in FIGS. 3-14 but is to be construed as a logistic definition. FIGS. 15a and 15b should be viewed as one illustration, the steps of the operation starting from the upper line of FIG. 15a and ending at the bottom line of FIG. 15b. The trays A-H are lined up for discharge in the first line of FIG. 15a. Tray A is conveyed to position 2 in the second line and the discharge conveyor section 9 is tilted in the third line so as to discharge the article on tray A. Then, in the fourth line, tray A is conveyed to position 4 and tray B is conveyed onto position 1. In the fifth line, the discharge conveyor section 9 is tilted back to the initial position, the article in tray B is discharged to th side opposite to th side th article in tray A was discharged to, and tray A is ready for being conveyed onto th subsequent conveyor section which happens in line 6. The procedure continues in the subsequent lines in FIG. 15b. In th xample shown, all tray are to be emptied at the discharge station, but it is naturally possible and often preferred that some of the trays are passed through the discharge conveyor section onto other discharge stations.

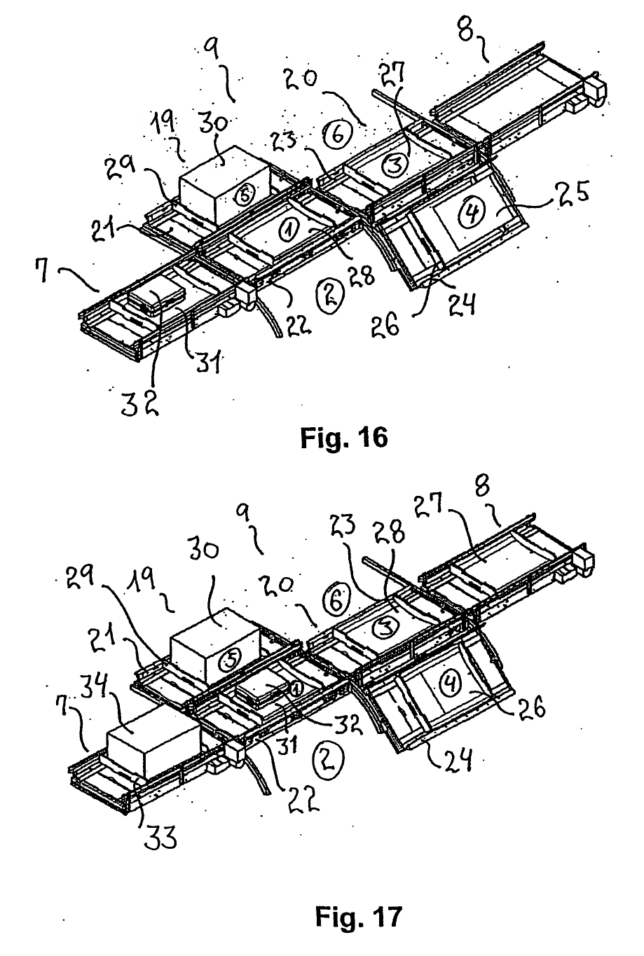

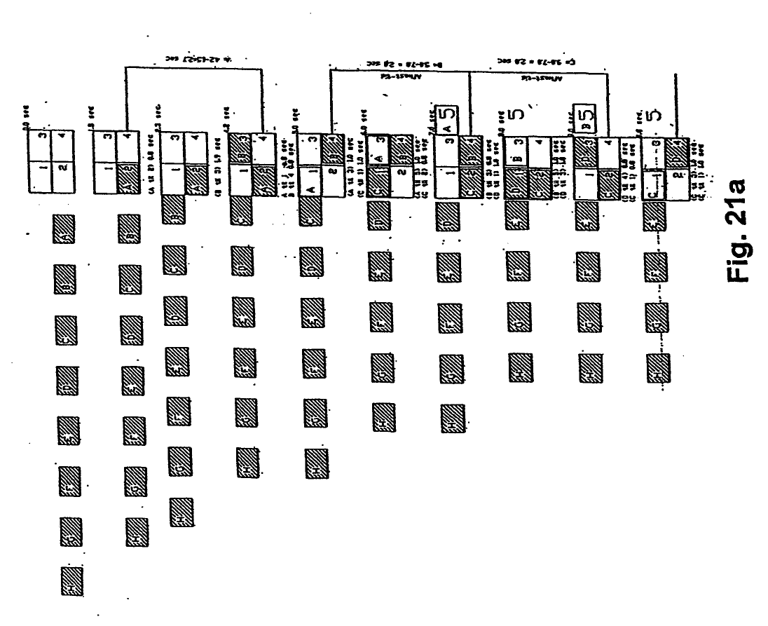

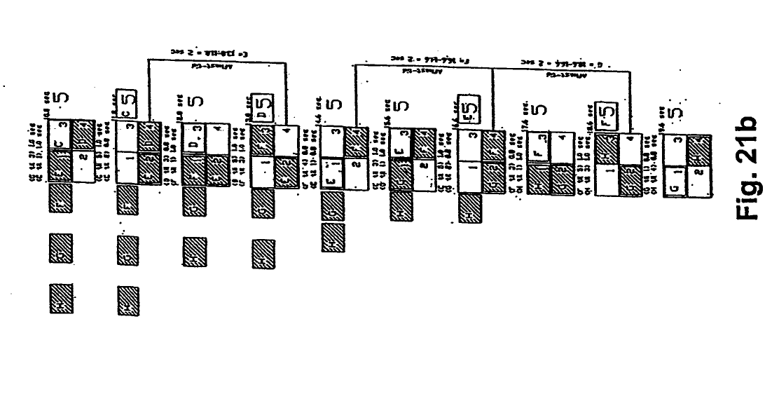

A different embodiment of the second aspect of the present invention is shown in FIGS. 16-20 with a discharge sequence illustrated in FIGS. 21a and 21b. The discharge conveyor section 9 of this embodiment comprises two separate discharge conveyor sections 19, 20 arranged adjacent, each comprising a first conveyor means 21, 23, indicated with positions number 5 and 3, and a second conveyor means 22, 24, indicated with position numbers 1 and 4, respectively. The positions 1-6 does not indicate the specific conveyor means 21-24, rather the positions that may be taken of the conveyor means 21-24 which is more clear for positions 1-4 from FIGS. 21a and 21b. The discharge conveyor sections 19, 20 are movable between two positions, a first in which discharge conveyor section 19 is shown in FIG. 16 where the second conveyor means 22 closes the transport path of the conveyor, and a second position in which discharge conveyor section 20 is shown in FIG. 16 where the first conveyor means 23 doses the transport path of the conveyor, whereas the second conveyor means 24 is in a tilted position in which an article 25 is discharged from a tray 26. An empty tray 27 is present on the first conveyor means 23, another empty tray 28 is present on the second conveyor means 22 of the discharge conveyor 19 whereas a tray 29 with an article thereon 30 is present on the first conveyor means 21. A new tray 31 with an article thereon 32 is approaching the discharge conveyor section 9 from the preceding conveyor section 7.

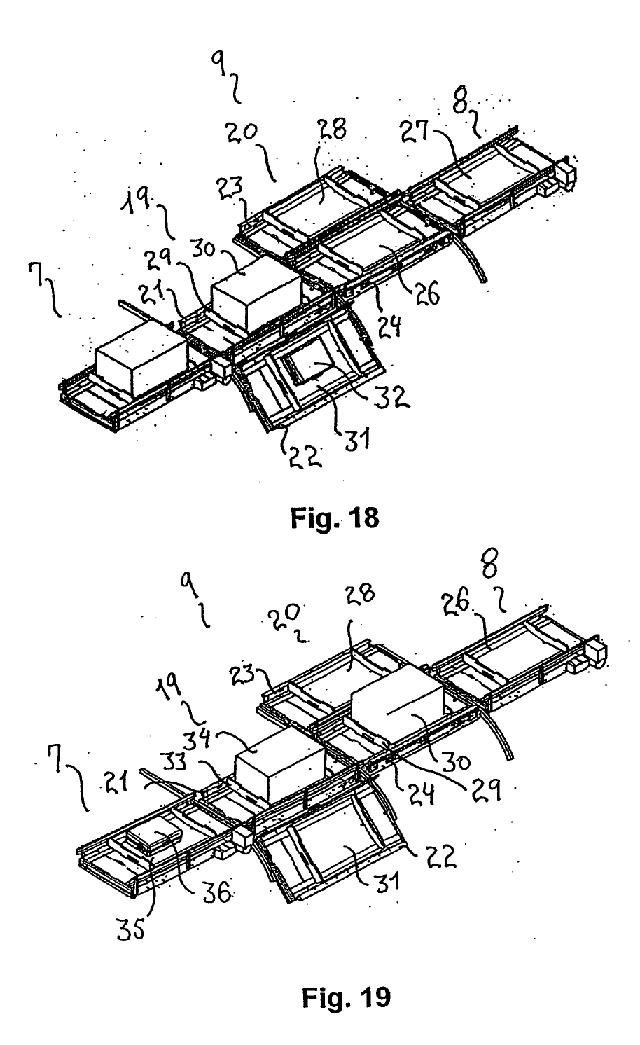

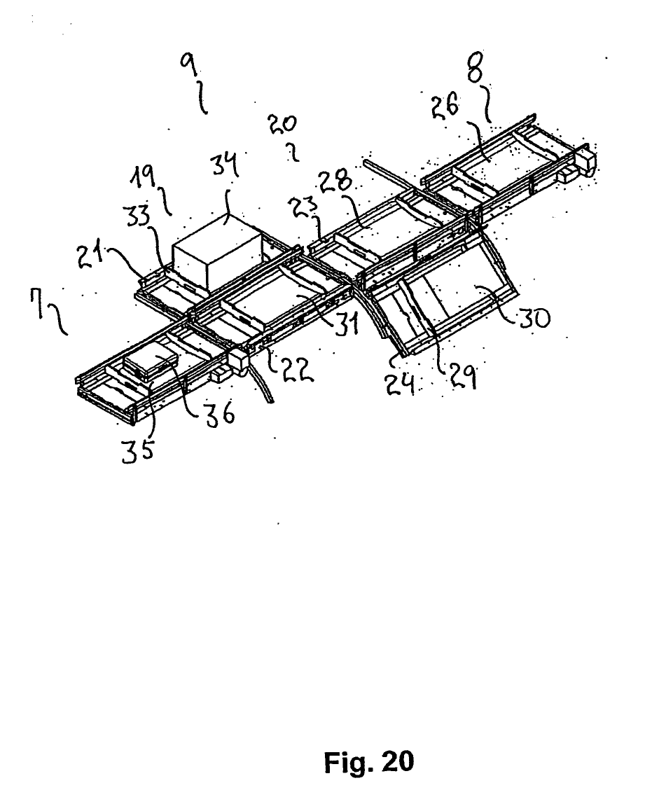

In FIG. 17, the trays 27, 28, 31 on the transport path of the conveyor have been advanced one step and a new tray 33 with an article thereon 34 is present on the preceding conveyor 7 whereas the empty tray 27 has left the discharge conveyor section 9 to the subsequent conveyor section 8. The position of the two discharge conveyor sections 19, 20 has changed in FIG. 18 so that the first conveyor means 21 and the second conveyor means 24 now form part of the transport path of the conveyor. The article 25 on the first conveyor means 24 is now discharged and the article 32 on the other first conveyor means 22 is about to be discharged while the tray 31 is retained on the first conveyor means 21 by means of retaining means. In FIG. 19, the trays 26, 29 33 on the transport part of the conveyor have be n advanced another step and another new tray 35 with an articl 36 thereon is approaching the discharge conv yor section 9 from the preceding conveyor section 7. The positions of the two discharge conveyor sections 19, 20 are again changed In FIG. 20 so as to discharg article 30. It is of cause not-necessary to discharge all articles arriving to the discharge conveyor section 9, one advantage of the present invention is that the transport path of the conveyor is complete most of the time during operation so that trays with or without articles thereon may pass the discharge conveyor section 9.

The discharge sequence illustrated in FIGS. 21a and 21b allows only for discharge of articles to one side of the conveyor but a similar sequence could naturally be constructed in which discharge to both sides is allowed for. In the first line of FIG. 21a, the trays A-H are lined up for discharge. Tray A is conveyed onto position 2 in the second line and the discharge conveyor section 19 is tilted In the third line so that tray A is, emptied. Tray B is in the fourth line conveyed past position 1 to position 3 and In the fifth line is the first discharge conveyor section 15 returned to the initial position whereas the second discharge conveyor section 20 is tilted, whereby tray A is ready for being conveyed past position 3 to the subsequent conveyor 8 and tray B is emptied. Tray A is In the sixth line conveyed onto position 3 and tray C is conveyed onto position 1 that is now ready to receive the new tray C. In the seventh line, the first discharge conveyor section 19 is tilted so that tray C is emptied and tray A is conveyed onto the subsequent conveyor section 8 so that the second discharge conveyor section 20 can be returned to the initial position in line eight so that the emptied tray B is ready for being conveyed onto the subsequent conveyor section 8. In line eight, tray D is also conveyed onto position 1 and in line nine further onto position 3 that is ready to receive because tray B is conveyed onto the subsequent conveyor section 8. The following lines in FIG. 21a and In FIG. 21b can easily be understood from the above description.

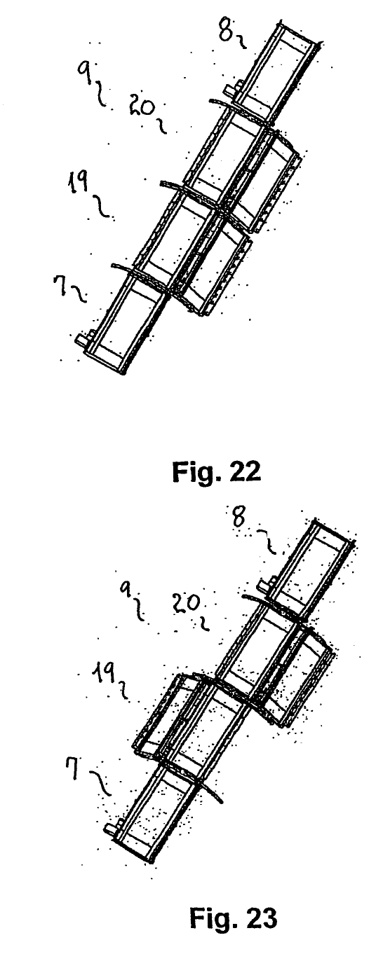

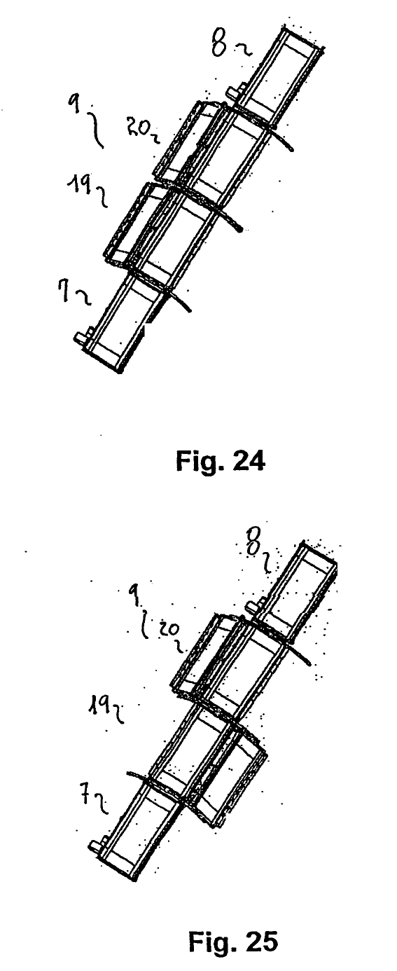

A third embodiment of a discharge device according to the second aspect of the present invention and having two consecutive sets of two, parallel discharge conveyor units for double-sided discharge is shown in FIGS. 22-25 with the four different possible operational positions.

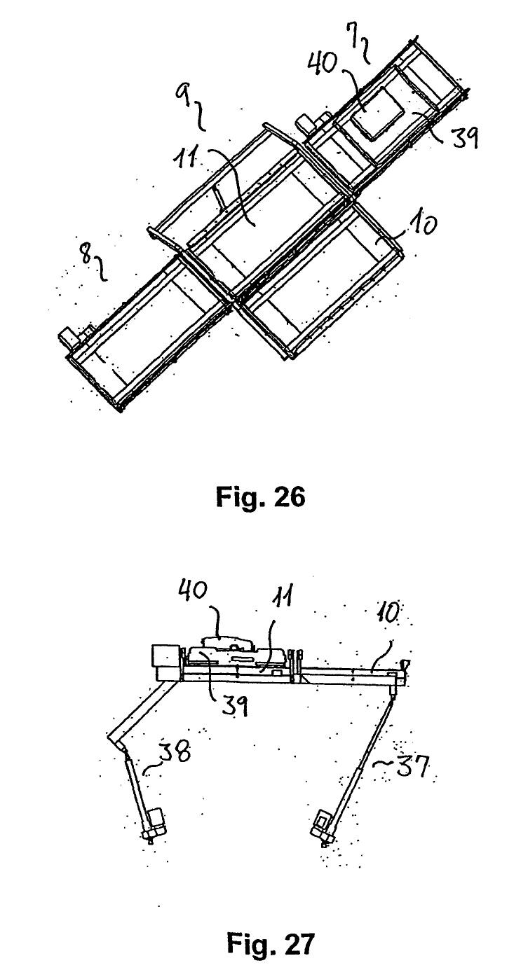

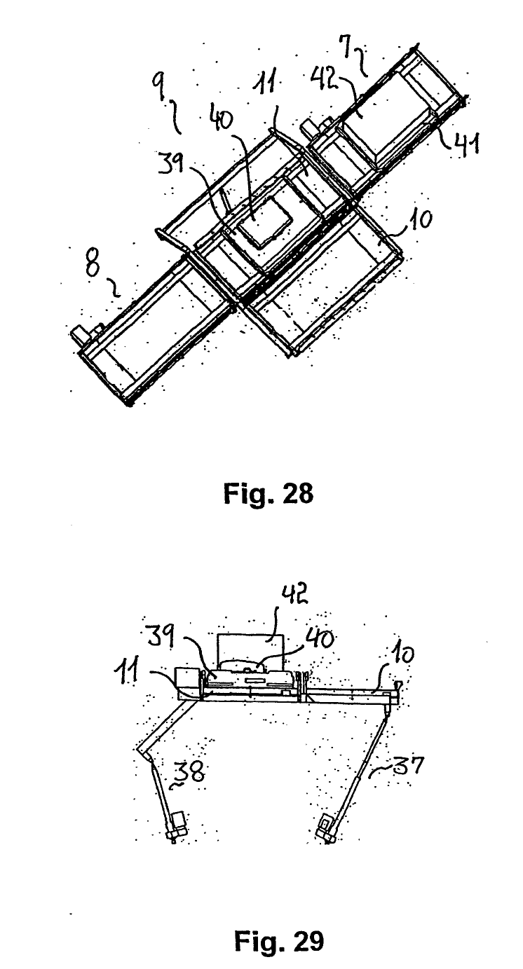

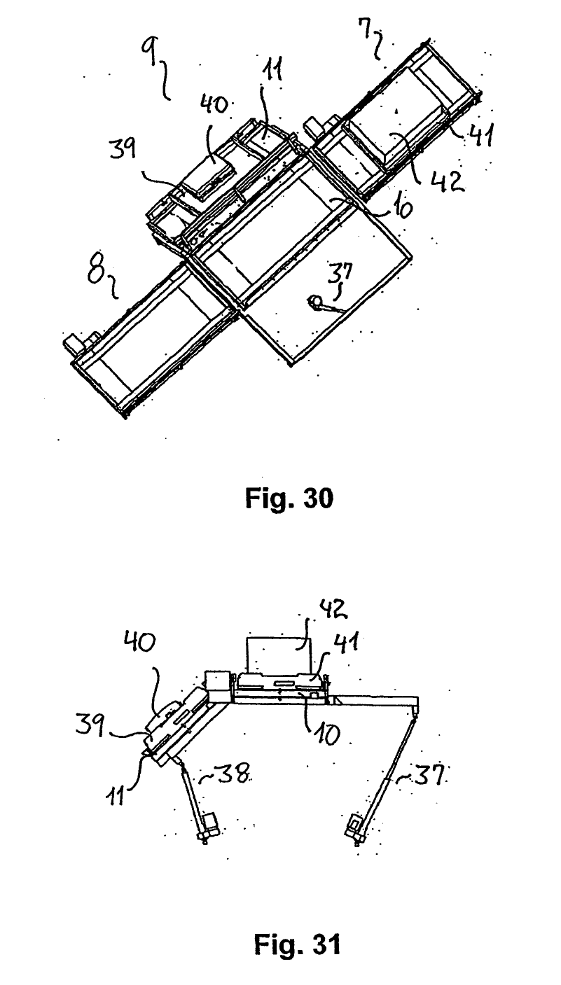

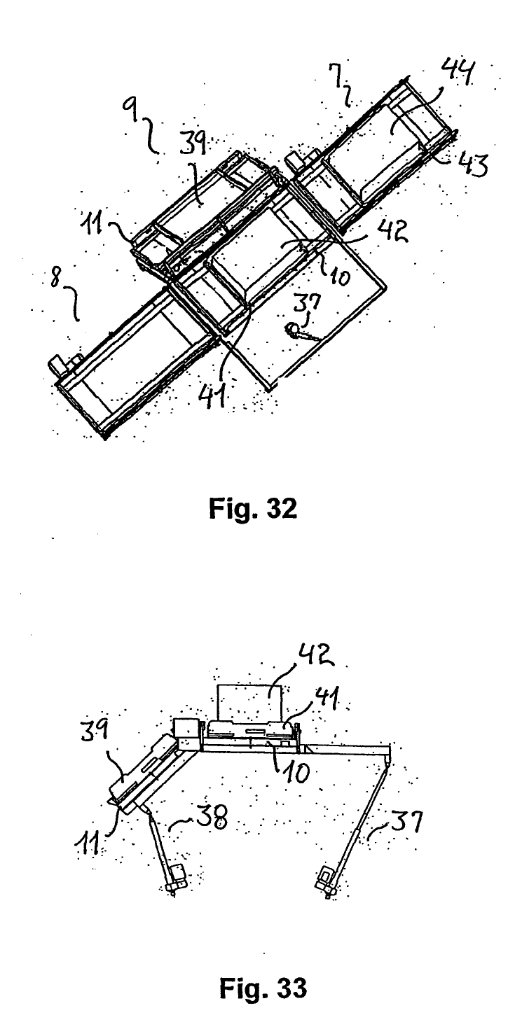

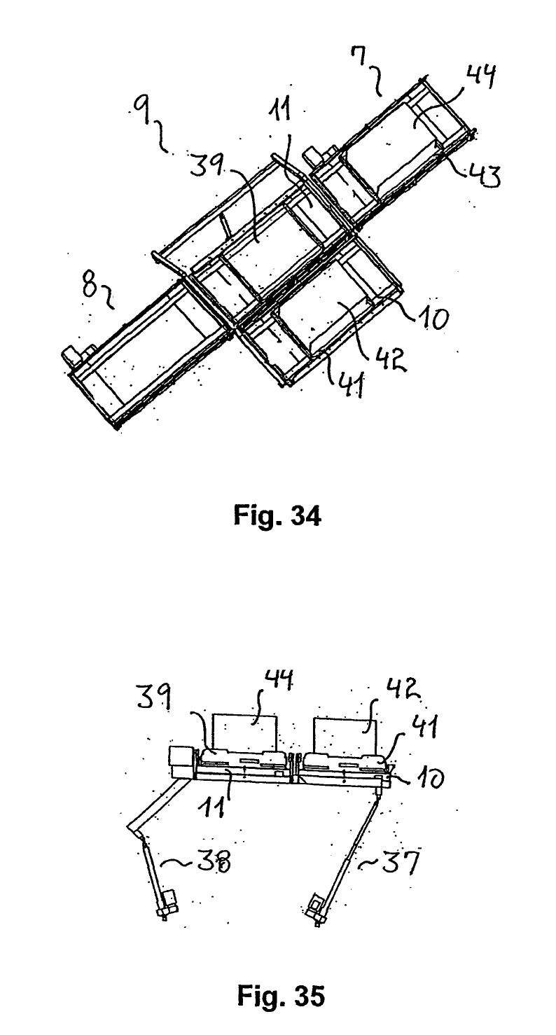

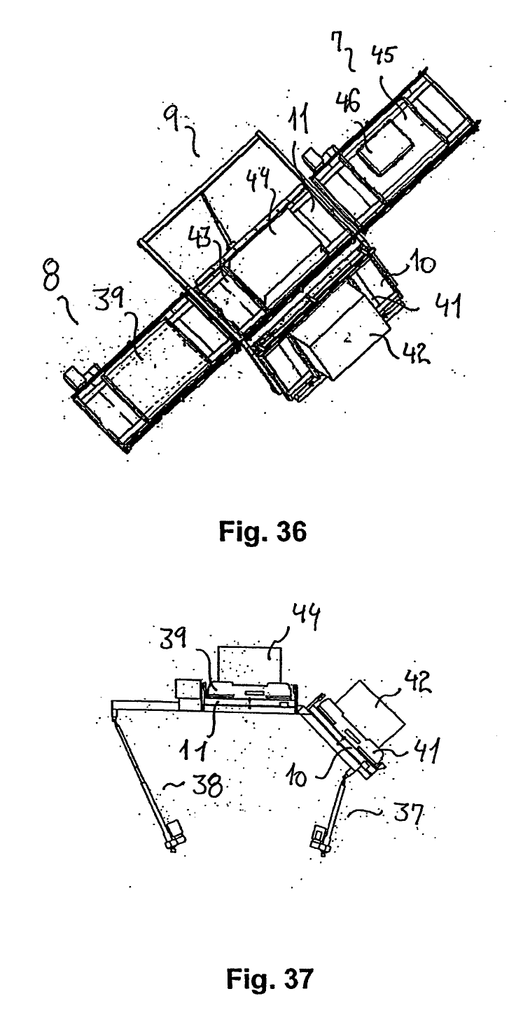

A fourth embodiment of a discharge device according to the second aspect of the present invention and having two, parallel discharg conv yor units for two-sided discharg is shown in FIGS. 26-37. The fourth embodim nt deviates from the first embodiment in that the two conveyor units 10, 11 of the discharg device 9 are not fixed with a constant angle there between but are hinged and has s parate activation means 37, 38 for raising and lowering the two conveyor units 10, 11, respectively. A first operational step 1s shown in FIGS. 26 and 27 in which the second conveyor unit 11 closes the transport path of the conveyor and a tray 39 with an article 40 thereon is approaching the discharge device 9 from the preceding conveyor section 7. In the next step shown in FIGS. 28 and 29, the tray 39 is conveyed onto the second conveyor unit 11 while a new tray 41 with an article thereon 42 is conveyed onto the preceding conveyor section 7. In the following step shown in FIGS. 30 and 31, the two discharge conveyor units 10, 11 are moved to the left to discharge the article 40 on the tray 39 position on the second discharge conveyor unit 11. The left activation means 38 is lowered so that the second discharge conveyor unit 11 will be in a lowered position. The next step is to advance the tray 41 from the preceding conveyor 7 to the first discharge conveyor unit 10 as shown in FIGS. 32 and 33, and advancing a new tray 43 with a now article 44 thereon to the preceding conveyor unit 7. Now, the discharge conveyor units 10, 11 are moved back such that the second conveyor unit 11 now forms part of and dosing the transport path of the conveyor. The last shown operational step in FIGS. 36 and 37 comprises the tilting of the first conveyor unit 10 with the tray 41 thereon so as to discharge the article 42 in the tray 41. The tilting is effectuated by means of the activation means 37, 38. At the same time, the trays 39, 43 on the transport path of the conveyor are advanced one step and a new tray 45 with an article 46 thereon is conveyed onto the preceding conveyor section 7.

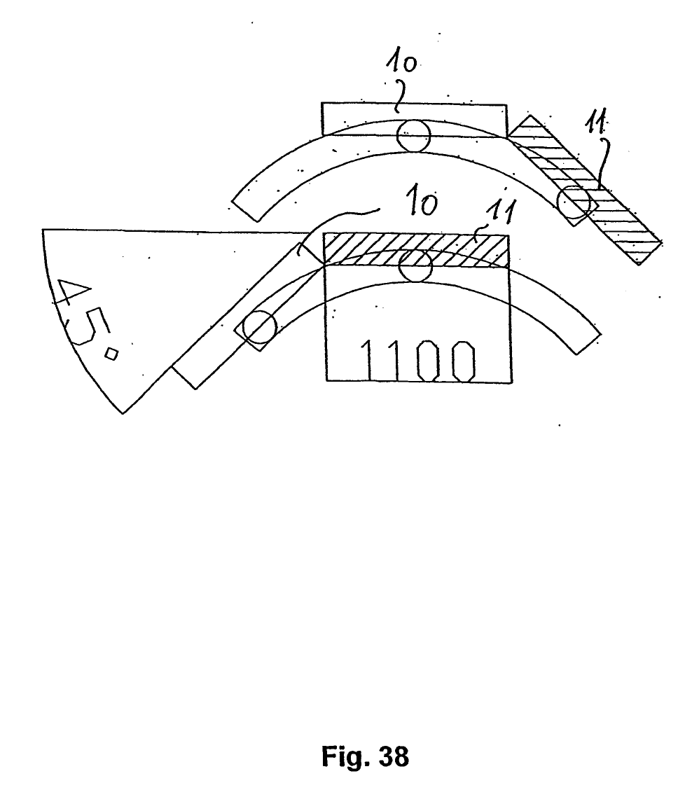

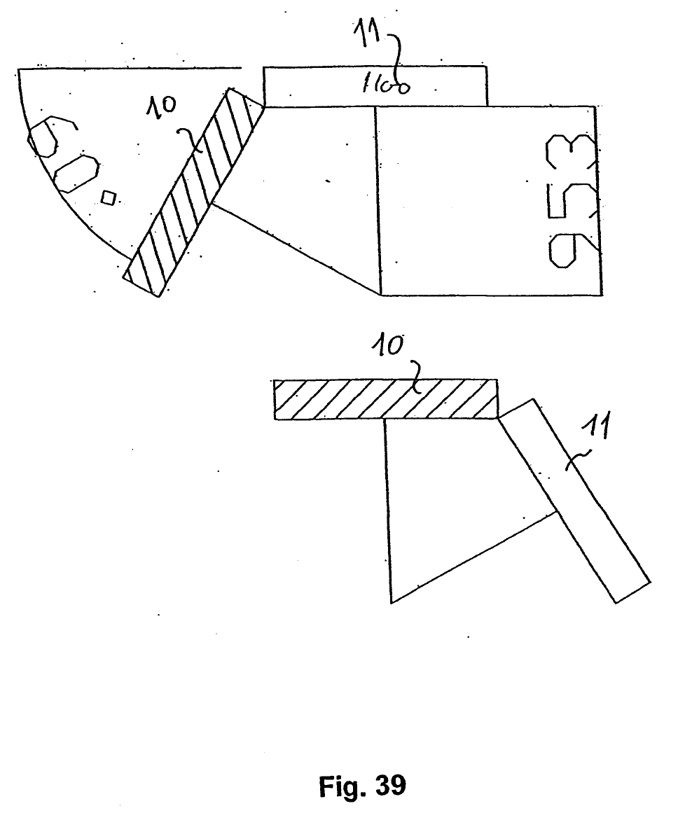

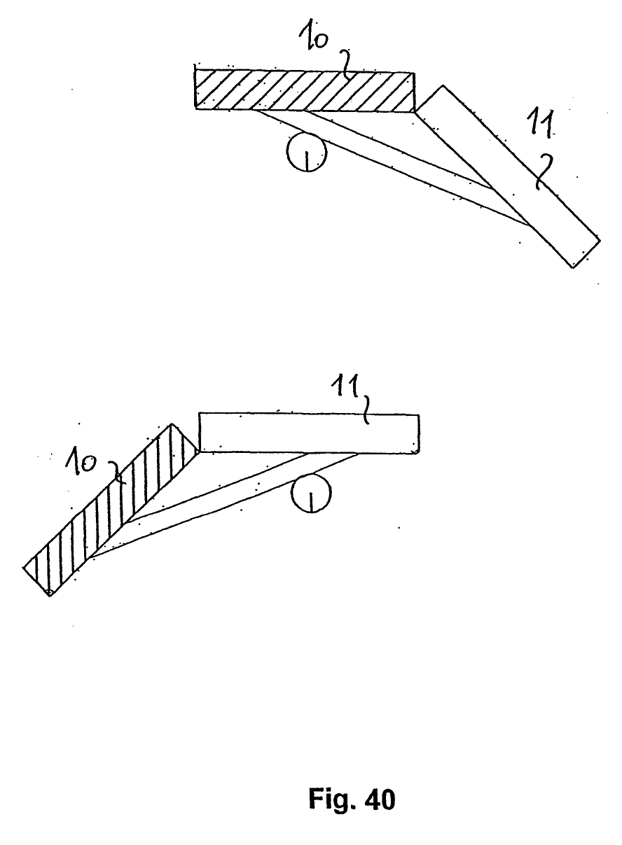

FIGS. 38-40 shows possible arrangement of two parallel and connected conveyor sections 10, 11 for two-sided discharge.

1. A method for providing a correct orientation of articles prior to induction on a main conveyor, comprising the steps of
(a) conveying the article from a feeding conveyor means onto an article-supporting plane of a first conveyor means in a receiving position thereof, on which plane a first face of the article is supported,
(b) determining from physical characteristics of the article whether or not the orientation of the article is to be changed,
(c) selectively turning the first conveyor means as well as a second conveyor means about an axis being substantially parallel to a transport direction of the first and the second conveyor means so that the article becomes solely supported by a second face on an articles-supporting plane of the second conveyor, and continue said turning until the articles-supporting plane of the second conveyor is oriented substantially parallel to the article-supporting plane of the first conveyor in its receiving position so as to change the orientation of the article, and
(d) conveying the article from the first conveyor means, respectively from the second conveyor means, in the transport direction thereof for induction onto a main conveyor.

2. A method according to claim 1, wherein step (b) of determining whether the orientation is to be changed comprises the steps of
(b1) detecting a first measure of the width of the article in a direction transverse to the transport direction by means of width detection means and providing a first output to a control unit accordingly,
(b2) detecting a second measure of the height of the article in a direction perpendicularly to the transport direction and to the width by means of height detection means and providing a second output to the control unit accordingly,
(b3) determining by means of the control unit whether or not the orientation of the article is to be changed from combining said first and second output with predetermined rules, and
(b4) selectively effectuating the turning by means of the control unit.

3. A method according to claim 2, wherein
the width detection means comprises a plurality of photo cells arranged with a substantially uniform mutual spacing in a direction transverse to the transport direction with lines of detection extending parallel through the path of conveyed articles,
the height detection means comprises a plurality of photo cells arranged with a substantially uniform mutual spacing in a direction perpendicularly to the transport direction and to the width with lines of detection extending parallel through the path of conveyed articles,
the first output and the second output indicating the number of photo cells of which the detection line is blocked by an article of the width detection means and the height detection means, respectively.

4. An apparatus for providing a correct orientation of articles prior to induction on a main conveyor, the apparatus comprising
a feeding conveyor having conveyor means for conveying articles in a transport direction thereof,
a tilt device having first conveyor means and second conveyor means defining a first and a second article-supporting surface extending substantially perpendicularly and having a common transport direction, the tilt device being pivotally arranged about an axis being substantially parallel to the transport direction,
tilting means for tilting the tilt device between a receiving position in which the first article-supporting surface is arranged to receive articles from the feeding conveyor and a tilted position in which the second article-supporting surface is arranged parallel to the first article-supporting surface in the receiving position,
a receiving conveyor having conveyor means arranged to receive articles from the first conveyor means when the tilt device is in the receiving position as well as from the second conveyor means when the tilt device is in the tilted position, and
a control unit being adapted to operate the conveyor means of the apparatus, to receive physical characteristics of an article situated on the first conveyor means in the receiving position of the tilt device, from these characteristics determine whether or not the orientation of the article is to be changed, selectively operating the tilting means so that the article becomes solely supported by the second articles-supporting plane, and continue said turning until the tilt device is in the tilted position.

5. An apparatus according to claim 4, wherein the receiving conveyor is arranged to receiv articles in one horizontal plane from the first as well as the second conveyor means.

6. An apparatus according to claim 4 or 5 comprising
width detection means for detecting a first measure of the width of the article in a direction transverse to the transport direction and providing a first output to a control unit accordingly, and
height detection means for detecting a second measure of the height of the article in a direction perpendicularly to the transport direction as well as to the width and providing a second output to the control unit accordingly,
the first output and the second output constituting physical characteristics of the article.

7. An apparatus according to claim 6, wherein
the width detection means comprises a plurality of photo cells arranged with a substantially uniform mutual spacing in a direction transverse to the transport direction with lines of detection extending parallel through the path of conveyed articles,
the height detection means comprises a plurality of photo cells arranged with a substantially uniform mutual spacing in a direction perpendicularly to the transport direction and to the width with lines of detection extending parallel through the path of conveyed articles,
the first output and the second output indicating the number of photo cells of which the detection line is blocked by an article of the width detection means and the height detection means, respectively.

8. A conveyor comprising
a plurality of conveyor sections each comprising conveyor means having a transport direction and being arranged to form a single conveying path, and
a plurality of trays for being conveyed along said conveying path by means of said conveyor means and each defining an article-supporting surface, wherein at least one of the conveyor sections is a discharge section for discharging articles from the trays, the discharge section comprising
a first unit having first conveyor means and securing means for preventing a tray situated on the first unit from sliding off the first unit when situated in a position transversally inclined with respect to the transport direction thereof,
a second unit arranged parallel to the first unit and having second conveyor means, and
shifting means for shifting the first unit transversally with respect to the transport direction from a conveying position, in which the subsequent conveyor section and the preceding conveyor section are interconnected by means of the first unit forming part of the conveyor path, and to a discharge position in which a tray situated on the first unit is transversally inclined with respect to the transport direction so as to discharge an article supported on the tray, the shifting means simultaneously shifting the second unit into a conveying position thereof in which the subsequent conveyor section and the preceding conveyor section are interconnected by means of the second unit forming part of the conveying path.

9. A conveyor according to claim 8, wherein the second unit comprises securing means for preventing a tray situated on the second unit from sliding off the second unit when situated in a position transversally inclined with respect to the transport direction hereof, the shifting means further being arranged for shifting the first unit from the discharge position and to the conveying position and simultaneously shifting the second unit transversally with respect to the transport direction to a discharge position in which a tray situated on the second unit is transversally inclined with respect to the transport direction so as to discharge an article supported on the tray.

10. A conveyor according to claim 8 or 9, wherein at least two immediately adjacent conveyor sections are discharge stations arranged to discharge articles to the same article-receiving means.

11. A conveyor according to any of claims 8-10, wherein a tray supporting plane of the first unit and a tray supporting plane of the second unit are arranged with a constant angle there between.

12. A conveyor according to claim 11, wherein the angle is in the range of 120-150 degrees, preferably of 130-140 degrees.

13. A conveyor according to any of claims 8-12, wherein said trays have an upper surface of a concav shape as viewed in a cross-section perpendicular to the transport direction of the conveyor.

14. A conveyor according to any of claims 8-13, wherein the upper surface of said trays are coated with a friction increasing material.

15. A conveyor according to any of claim 8-15, wherein the trays when being in the discharge position are inclined in the range of 30-60 degrees, preferably in the range of 40-50 degrees, with respect to the position of the trays being in the article-supporting and -conveying position.
